(19) United States
(12) Patent Application Publication
(10) Pub. No.: US 2022/0277340 A1
(43) Pub. Date: Sep. 1, 2022

(54) METHODS AND APPARATUS TO ESTIMATE AN AUDIENCE SIZE OF A PLATFORM BASED ON AN AGGREGATED TOTAL AUDIENCE

(71) Applicant: The Nielsen Company (US), LLC, New York, NY (US)

(72) Inventors: Michael R. Sheppard, Holland, MI (US); DongBo Cui, New York, NY (US); David Forteguerre, Brooklyn, NY (US); Jessica Lynn White, Plant City, FL (US); Edward Murphy, North Stonington, CT (US)

(21) Appl. No.: 17/187,770

(22) Filed: Feb. 27, 2021

(51) Int. Cl. G06Q 30/02; G06F 17/11

(52) U.S. Cl. CPC G06Q 30/0246; G06F 17/11

(57) ABSTRACT

A disclosed example apparatus includes a communication interface to: access impression count data corresponding to a plurality of platforms; and access deduplicated total audience size data; an arithmetic logic unit to: generate a total impressions count by aggregating the impression count data corresponding to the plurality of platforms; generate an estimated per-platform impression count by dividing the total impressions count by a number of the platforms, a solver controller to: instruct a numerical solver to utilize the number of the platforms, the deduplicated total audience size data, and the estimated per-platform impression count to estimate the deduplicated audience size of a first platform of the platforms; and store the deduplicated audience size of the first platform in memory.

### FIELD OF THE DISCLOSURE

This disclosure relates generally to computer-based audience measurement, and more particularly, to estimating an audience size of a platform based on an aggregated total audience.

### BACKGROUND

Estimating audience reach of media has been used by broadcasters and advertisers to determine viewership information and could be useful for digital advertising. The success of advertisement placement strategies is dependent on the accuracy that technology can achieve in generating audience metrics.

### BRIEF DESCRIPTION OF THE DRAWINGS

FIG. 1 illustrates an example network-based communication system to log impressions of media to estimate sizes of audiences exposed to the media.

FIG. 2 illustrates an example environment depicting an example audience measurement entity (AME) connected to example media platform providers and customer computers.

FIG. 3 is a block diagram of an example audience estimator of FIG. 2.

FIG. 4 represents example operations to implement the example audience estimator of FIG. 3.

FIG. 5 is a flowchart representative of example machine readable instructions that may be executed to implement the example audience estimator of FIGS. 2 and/or 3 to estimate audience size per platform and impression count per platform based on the deduplicated total audience size, the number of platforms, and the total impressions count from all the platforms.

FIG. 6 is a flowchart representative of example machine readable instructions that may be executed to implement an example solver controller of the example audience estimator of FIGS. 2 and/or 3.

FIG. 7 is a block diagram of an example processing platform structured to execute the instructions of FIG. 5 to implement the example audience estimator of FIGS. 2 and/or 3.

FIG. 8 is a block diagram of an example software distribution platform to distribute software (e.g., software corresponding to the example computer readable instructions of FIG. 7) to client devices such as consumers (e.g., for license, sale and/or use), retailers (e.g., for sale, re-sale, license, and/or sub-license), and/or original equipment manufacturers (OEMs) (e.g., for inclusion in products to be distributed to, for example, retailers and/or to direct buy customers).

The figures are not to scale. In general, the same reference numbers will be used throughout the drawing(s) and accompanying written description to refer to the same or like parts. Unless specifically stated otherwise, descriptors such as “first,” “second,” “third,” etc. are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name.

### DETAILED DESCRIPTION

Techniques for monitoring user access to an Internet-accessible media, such as digital television (DTV) media and digital content ratings (DCR) media, have evolved significantly over the years. Internet-accessible media is also known as digital media. In the past, such monitoring was done primarily through server logs. In particular, entities serving media on the Internet would log the number of requests received for their media at their servers. Basing Internet usage research on server logs is problematic for several reasons. For example, server logs can be tampered with either directly or via zombie programs, which repeatedly request media from the server to increase the server log counts. Also, media is sometimes retrieved once, cached locally and then repeatedly accessed from the local cache without involving the server. Server logs cannot track such repeat views of cached media. Thus, server logs are susceptible to both over-counting and under-counting errors.

The inventions disclosed in Blumenau, U.S. Pat. No. 6,108,637, which is hereby incorporated herein by reference in its entirety, fundamentally changed the way Internet monitoring is performed and overcame the limitations of the server-side log monitoring techniques described above. For example, Blumenau disclosed a technique wherein Internet media to be tracked is tagged with monitoring instructions. In particular, monitoring instructions are associated with the hypertext markup language (HTML) of the media to be tracked. When a client requests the media, both the media and the monitoring instructions are downloaded to the client. The monitoring instructions are, thus, executed whenever the media is accessed, be it from a server or from a cache. Upon execution, the monitoring instructions cause the client to send or transmit monitoring information from the client to a content provider site. The monitoring information is indicative of the manner in which content was displayed.

In some implementations, an impression request or ping request can be used to send or transmit monitoring information by a client device using a network communication in the form of a hypertext transfer protocol (HTTP) request. In this manner, the impression request or ping request reports the occurrence of a media impression at the client device. For example, the impression request or ping request includes information to report access to a particular item of media (e.g., an advertisement, a webpage, an image, video, audio, etc.). In some examples, the impression request or ping request can also include a cookie previously set in the browser of the client device that may be used to identify a user that accessed the media. That is, impression requests or ping requests cause monitoring data reflecting information about an access to the media to be sent from the client device that downloaded the media to a monitoring entity and can provide a cookie to identify the client device and/or a user of the client device. In some examples, the monitoring entity is an audience measurement entity (AME) that did not provide the media to the client and who is a trusted (e.g., neutral) third party for providing accurate usage statistics (e.g., The Nielsen Company, LLC). Since the AME is a third party relative to the entity serving the media to the client device, the cookie sent to the AME in the impression request to report the occurrence of the media impression at the client device is a third-party cookie. Third-party cookie tracking is used by measurement entities to track access to media accessed by client devices from first-party media servers.

There are many database proprietors operating on the Internet. These database proprietors provide services to large numbers of subscribers. In exchange for the provision of services, the subscribers register with the database proprietors. Examples of such database proprietors include social network sites (e.g., Facebook, Twitter, MySpace, etc.), multi-service sites (e.g., Yahoo!, Google, Axiom, Catalina, etc.), online retailer sites (e.g., Amazon.com, Buy.com, etc.), credit reporting sites (e.g., Experian), streaming media sites (e.g., YouTube, Hulu, etc.), etc. These database proprietors set cookies and/or other device/user identifiers on the client devices of their subscribers to enable the database proprietors to recognize their subscribers when they visit their web sites.

The protocols of the Internet make cookies inaccessible outside of the domain (e.g., Internet domain, domain name, etc.) on which they were set. Thus, a cookie set in, for example, the facebook.com domain (e.g., a first party) is accessible to servers in the facebook.com domain, but not to servers outside that domain. Therefore, although an AME (e.g., a third party) might find it advantageous to access the cookies set by the database proprietors, they are unable to do so.

The inventions disclosed in Mazumdar et al., U.S. Pat. No. 8,370,489, which is incorporated by reference herein in its entirety, enable an AME to leverage the existing databases of database proprietors to collect more extensive Internet usage by extending the impression request process to encompass partnered database proprietors and by using such partners as interim data collectors. The inventions disclosed in Mazumdar accomplish this task by structuring the AME to respond to impression requests from clients (who may not be a member of an audience measurement panel and, thus, may be unknown to the AME) by redirecting the clients from the AME to a database proprietor, such as a social network site partnered with the AME, using an impression response. Such a redirection initiates a communication session between the client accessing the tagged media and the database proprietor. For example, the impression response received at the client device from the AME may cause the client device to send a second impression request to the database proprietor. In response to the database proprietor receiving this impression request from the client device, the database proprietor (e.g., Facebook) can access any cookie it has set on the client to thereby identify the client based on the internal records of the database proprietor. In the event the client device corresponds to a subscriber of the database proprietor, the database proprietor logs/records a database proprietor demographic impression in association with the user/client device.

As used herein, an impression is defined to be an event in which a home or individual accesses and/or is exposed to media (e.g., an advertisement, content, a group of advertisements and/or a collection of content). In Internet media delivery, a quantity of impressions or impression count is the total number of times media (e.g., content, an advertisement, or advertisement campaign) has been accessed by a web population (e.g., the number of times the media is accessed). In some examples, an impression or media impression is logged by an impression collection entity (e.g., an AME or a database proprietor) in response to an impression request from a user/client device that requested the media. For example, an impression request is a message or communication (e.g., an HTTP request) sent by a client device to an impression collection server to report the occurrence of a media impression at the client device. In some examples, a media impression is not associated with demographics. In non-Internet media delivery, such as television (TV) media, a television or a device attached to the television (e.g., a set-top-box or other media monitoring device) may monitor media being output by the television. The monitoring generates a log of impressions associated with the media displayed on the television. The television and/or the connected device may transmit impression logs to the impression collection entity to log the media impressions.

A user of a computing device (e.g., a mobile device, a tablet, a laptop, etc.) and/or a television may be exposed to the same media via multiple devices (e.g., two or more of a mobile device, a tablet, a laptop, etc.) and/or via multiple media types (e.g., digital media available online, digital TV (DTV) media temporarily available online after broadcast, TV media, etc.). For example, a user may start watching the Walking Dead television program on a television as part of TV media, pause the program, and continue to watch the program on a tablet as part of DTV media. In such an example, the exposure to the program may be logged by an AME twice, once for an impression log associated with the television exposure, and once for the impression request generated by a tag (e.g., census measurement science (CMS) tag) executed on the tablet. Multiple logged impressions associated with the same program and/or same user are defined as duplicate impressions. Duplicate impressions are problematic in determining total reach estimates because one exposure via two or more cross-platform devices may be counted as two or more unique audience members. As used herein, reach is a measure indicative of the demographic coverage achieved by media (e.g., demographic group(s) and/or demographic population(s) exposed to the media). For example, media reaching a broader demographic base will have a larger reach than media that reached a more limited demographic base. The reach metric may be measured by tracking impressions for known users (e.g., panelists or non-panelists) for which an audience measurement entity stores demographic information or can obtain demographic information. Deduplication is a process that is used to adjust cross-platform media exposure totals by reducing (e.g., eliminating) the double counting of individual audience members that were exposed to media via more than one platform and/or are represented in more than one database of media impressions used to determine the reach of the media.

As used herein, a unique audience is based on audience members distinguishable from one another. That is, a particular audience member exposed to particular media is measured as a single unique audience member regardless of how many times that audience member is exposed to that particular media or the particular platform(s) through which the audience member is exposed to the media. If that particular audience member is exposed multiple times to the same media, the multiple exposures for the particular audience member to the same media is counted as only a single unique audience member. In this manner, impression performance for particular media is not disproportionately represented when a small subset of one or more audience members is exposed to the same media an excessively large number of times while a larger number of audience members is exposed fewer times or not at all to that same media. By tracking exposures to unique audience members, a unique audience measure may be used to determine a reach measure to identify how many unique audience members are reached by media. In some examples, increasing unique audience and, thus, reach, is useful for advertisers wishing to reach a larger audience base.

Notably, although third-party cookies are useful for third-party measurement entities in many of the above-described techniques to track media accesses and to leverage demographic information from database proprietors, use of third-party cookies may be limited or may cease in some or all online markets. That is, use of third-party cookies enables sharing anonymous personally identifiable information (PII) across entities which can be used to identify and deduplicate audience members across database proprietor impression data. However, to reduce or eliminate the possibility of revealing user identities outside database proprietors by such anonymous data sharing across entities, some websites, internet domains, and/or web browsers will stop (or have already stopped) supporting third-party cookies. This will make it more challenging for third-party measurement entities to track media accesses via first-party servers. That is, although first-party cookies will still be supported and useful for media providers to track accesses to media via their own first-party servers, neutral third parties interested in generating neutral, unbiased audience metrics data will not have access to the impression data collected by the first-party servers using first-party cookies. Examples disclosed herein may be implemented with or without the availability of third-party cookies because, as mentioned above, the datasets used in the deduplication process are generated and provided by database proprietors, which may employ first-party cookies to track media impressions from which the datasets are generated.

In many cases, AMEs may only have access to partial census-level data (e.g., a total census-level impression count for a single dimension across all demographics or a total census-level impression count for all dimensions across all demographics). As used herein, census data corresponds to impressions (e.g., exposures to a media item by an audience member) logged for a general audience in a population regardless of whether the impressions correspond to audience members that are identifiable by the AME. In such examples, census-level impressions are collected as anonymous impression data. In examples disclosed herein, a database proprietor collects demographic impression data by monitoring media accesses by its subscribers and logging corresponding impressions in association with demographic data collected from its subscribers. In examples disclosed herein, such demographic impression data is also referred to as panel data or panel impression data because it corresponds to known subscribers of the database proprietor which form a database proprietor (e.g., DP) panel of audience members.

In examples disclosed herein, a relation between the deduplicated audience size of an individual platform to the deduplicated total audience size of the platforms and the population estimate is shown in Equation 1 below.

$$a = U ( 1 - {( 1 - \frac{{A}_{}}{U} )}^{1 / n} ) \qquad Equation 1$$

In Equation 1 above, the variable a is the deduplicated audience (e.g., unique audience size) of an individual platform (e.g., website, media provider, etc.). The variable U is the population estimate (e.g., the universal estimate, the universe estimate). The variable n is the number of platforms, and the variable A_{⋅} (e.g., A-dot, A. , A_dot) is the deduplicated total audience size. The deduplicated total audience size A_{⋅} is the known deduplicated audience of all the platforms, or the group of audience members that accessed at least one of the platforms contributing to the number of platforms n (e.g., the total number of unique audience members across all media platform providers of interest). Equation 1 above illustrates that according to basic probability theory regarding interacting platforms and an assumption of independence, knowing the universe estimate U, the number of platforms n, and the deduplicated total audience size A_{⋅} is enough information to estimate the deduplicated audience size of an individual platform a. However, with the inclusion of knowing additional information such as the total impressions count R_{⋅} across the n platforms, Equation 1 above may produce incorrect (e.g., logically inconsistent) estimates of the deduplicated audience size of an individual platform a. Examples disclosed herein include the below equations that, despite including total impressions count R_{⋅} across the n platforms, do not produce logically inconsistent estimates. In examples disclosed herein, a logically inconsistent estimate is an estimate (e.g., an audience size estimate) that assigns more audience members than impression counts. For example, an answer stating that there are ten unique audience members, and nine impression counts is logically inconsistent as the definition for being in the audience is that at least one impression was collected for the individual audience members. As such, to be logically consistent, nine impression counts would result in at most nine unique audience members (e.g., at most one unique audience member per each of the nine impressions).

Example Equations 2-A, 2-B, 2-C, and 2-D are solutions to the maximum entropy equation, where the z term is a placeholder constant representing the solution to the maximum entropy equation.

Example equations disclosed herein include an example maximum entropy solution shown in Equation 2-A below.

$${z}_{j}^{( a )} = \frac{{A}_{j}^{2}}{( Q - {A}_{j} ) ( {R}_{j} - {A}_{j} )} j = \{ 1 , 2 , … , n \} \qquad Equation 2 - A$$

The example maximum entropy solution includes Equations 2-A, 2-B, 2-C, and 2-D. Example Equation 2A above may be used to solve for the maximum entropy solution for the distribution of n-platforms with known audience size A and known impression counts R for an individual platform j {Aⱼ, Rⱼ}, along with deduplicated total audience size A_{⋅}. In examples disclosed herein, z is a constant representing the solution to the maximum entropy equation. Example Equation 2-B is shown below.

$${z}_{j}^{( i )} = 1 - \frac{{A}_{j}}{{R}_{j}} j = \{ 1 , 2 , … , n \} \qquad Equation 2 - B$$

In example Equation 2-B above, zⱼ is a constant representing the solution to the equation of 1 minus the quotient of the audience size A for an individual platform j divided by the impression count R for an individual platform j. Example Equation 2-C is shown below.

$${Z}_{} = \frac{( Q - {A}_{} )}{( U - {A}_{} )} \qquad Equation 2 - C$$

In example Equation 2-C above, z_{⋅} (e.g., z-dot) is used as the solution to the deduplicated total audience size A_{⋅}. The z_{⋅} constant is equal to the quotient of the pseudo-universe estimate Q minus the deduplicated total audience size A_{⋅} divided by the universe estimate U minus the deduplicated total audience size A_{⋅}. In examples disclosed herein, the pseudo-universe estimate Q is an estimate of what the population would have to be such that the total audience A_{⋅} would be predicted by independence. In examples disclosed herein, a prediction by independence means that a likelihood that audience members access media via a first platform is independent of a likelihood that those audience members also access media via a second platform. For example, an audience member accessing media via a first platform bears no correlation to the likelihood that the same audience member will access media via a second platform. In other examples, the pseudo-universe estimate Q can be described by a counterfactual statement “if there had been Q people as the universe estimate U, then the observations would have been independent.” The pseudo-universe estimate Q is the solution to example Equation 3 below. Example Equation 2-D is shown below.

$${z}_{} = 1 - \frac{{A}_{}}{U} \qquad Equation 2 - D$$

In example Equation 2-D above, z₀ (e.g., z-nought, z-zeroth) is used as a solution for the universe estimate U. The z₀ term is a constant referring to the sum of probabilities equal to one hundred percent, and the z₀ term may be used as a normalization constraint (e.g., a normalization factor) wherein every person in the universe estimate U has been accounted for. The z₀ term is equal to one minus the division of the deduplicated total audience size A_{⋅} divided by the universe estimate U. The pseudo-universe estimate Q is set to a constant value and is a solution for example Equation 3 shown below.

$$1 - \frac{{A}_{}}{Q} = {\prod }_{j = 1}^{n} ( 1 - \frac{{A}_{j}}{Q} ) \qquad Equation 3$$

In example Equation 3 above, the Equation is solved for the pseudo-universe-estimate Q. The Shannon Entropy of example Equation 2 is calculated using example Equation 4 below.

$$H ( S ) = - ( ( 1 ) log ( {z}_{0} ) + \frac{{A}_{}}{U} log ( {z}_{} ) + {\sum }_{j = 1}^{n} \frac{{R}_{j}}{U} log ( {z}_{j}^{( i )} ) + {\sum }_{j = 1}^{n} \frac{{A}_{j}}{U} log ( {z}_{j}^{( a )} ) \qquad Equation 4$$

In example Equation 4 above, z=e^{λ} and the Shannon Entropy is a linear combination of the constraints with corresponding Lagrange Multipliers λ. The example Entropy Equation (e.g., Equation 4) above is used to create Equation 5 below after incorporating (e.g., substituting) the deduplicated audience size of an individual platform a for the deduplicated audience size for a specific platform Aⱼ and incorporating (e.g., substituting) the estimated per-platform impression count r for the impression count for a specific platform Rⱼ. Without information to distinguish the platforms j, the deduplicated audience size for a specific platform Aⱼ may be assumed to be the deduplicated audience size of an individual platform a such that the deduplicated audience size is the same number for each of the platforms j. In addition, without information to distinguish the platforms j, the impression count for a specific platform Rⱼ may be assumed to be the estimated per-platform impression count r such that the impression count is the same number for each of the platforms j. Equation 5 below incorporates this assumption.

$$H ( S ) = - ( ( 1 ) log ( {z}_{0} ) + \frac{{A}_{}}{U} l o g ( {z}_{} ) + n \frac{r}{U} log ( {z}^{( i )} ) + n \frac{a}{U} log ( {z}^{( a )} ) \qquad Equation 5$$

Using the updated example Equation 5 above, example Equations 2-A, 2-B, 2-C, 2-D above can be updated to generate example Equation 6 below. In this example, Equations 2-A, 2-B are updated to generate Equations 6-A, 6-B, and Equations 6-C and 6-D remain the same as corresponding ones of Equations 2-C and 2-D.

$${z}^{( a )} = \frac{{a}^{2}}{( Q - a ) ( r - a )} \qquad Equation 6 - A$$

In example Equation 6-A above, the deduplicated audience size for a specific platform Aⱼ has been updated to represent the estimated deduplicated audience size for an individual platform a, and the impression count for a specific platform Rⱼ has been updated to be the estimated impression count r. Example Equation 6-B is shown below.

$${z}^{( i )} = 1 - \frac{a}{r} \qquad Equation 6 - B$$

In example Equation 6-B above, deduplicated audience size for a specific platform Aⱼ has been updated to represent the estimated deduplicated audience size for an individual platform a, and the impression count for a specific platform Rⱼ has been updated to be the estimated impression count r. Example Equation 6-C is shown below:

$${z}_{} = \frac{( Q - {A}_{} )}{( U - {A}_{} )} \qquad Equation 6 - C$$

In example Equation 6-C above, Equation 6-C is the same as Equation 2-C but is reproduced here to show that the z_{⋅} (e.g., z-dot) term is equal to the quotient of the pseudo-universe estimate Q minus the deduplicated total audience size A_{⋅} divided by the universe estimate U minus the deduplicated total audience size A_{⋅}. Example Equation 6-D is shown below:

$${z}_{0} = 1 - \frac{{A}_{}}{U} \qquad Equation 6 - D$$

As shown in example Equation 6-D above, Equation 6-D is the same as Equation 2-D but is reproduced here to show that the z₀(e.g., z-nought) term is equal to one minus the division of the deduplicated total audience size A_{⋅} divided by the universe estimate U.

Based on example Equation 5 above, example Equation 3, which defines pseudo-universe-estimate Q, can be updated to generate example Equation 7 below.

$$1 - \frac{{A}_{}}{Q} = {( 1 - \frac{a}{Q} )}^{n} \qquad Equation 7$$

In example Equation 7 above, the quotient of the deduplicated total audience size A_{⋅} divided by the pseudo-universe-estimate Q is related to the deduplicated audience size per platform a. Example Equation 8 below relates the deduplicated audience size of an individual platform a to the pseudo-universe-estimate Q and the deduplicated total audience size A_{⋅}. Example Equation 8 below is based on Equation 6-A above in which the constant z^{(a)} is equal to 1, due to the LaGrange Multiplier λ^{(a)}=0 in response to the variable a being the only unknown.

$$1 = {z}^{( a )} = \frac{{a}^{2}}{( Q - a ) ( r - a )} \qquad Equation 8$$

Example Equation 9 below is an audience estimation equation. Example Equation 9 can be generated by solving example Equation 8 for the pseudo-universe-estimate Q, substituting the pseudo-universe-estimate Q into example Equation 7 above.

$$1 - {A}_{} ( \frac{1}{a} - \frac{1}{r} ) = {( \frac{a}{r} )}^{n} \qquad Equation 9$$

As shown in example Equation 9 above, the variable a is the deduplicated audience size of each platform (e.g., website, a media provider, etc.). The variable r is the estimate of impression count data per platform (e.g., the total impressions count R_{⋅} data for all the platforms divided by the number of platforms n). The variable n is the number of platforms, and the variable A_{⋅} (e.g., A-dot, A., A_dot) is the known deduplicated audience size of the n number of platforms (e.g., the group of audience members that accessed at least one of the platforms contributing to the number of platforms n). Example Equation 10 below is an algebraic rearrangement of Equation 9.

$${A}_{} ( \frac{1}{a} - \frac{1}{r} ) + {( \frac{a}{r} )}^{n} = 1 \qquad Equation 10$$

In example Equation 10 above, the variable a is the deduplicated audience size of each platform (e.g., website, a media provider, etc.). The variable r is the estimate of impression count data per platform (e.g., the total impressions count R_{⋅} data for all the platforms divided by the number of platforms). The variable n is the number of platforms, and the variable A_{⋅} (e.g., A-dot, A., A_dot) is the known deduplicated audience size of all the platforms (e.g., the group of audience members that accessed at least one of the platforms contributing to the number of platforms n). The audience estimation equation (e.g., Equation 10) shows that knowing the deduplicated audience size of all the platforms, the number of platforms, and the estimate of impression count data (e.g., usable impression count data) allows an audience metrics entity to solve for the deduplicated audience size of each platform. Based on the nature of the audience estimation equation (e.g., Equation 10), a numerical solver, in some examples, can be used to estimate the deduplicated audience size of each platform a.

For example, the left-hand side of the audience estimation equation (e.g., Equation 10, above) may be a multiplication of a total deduplicated audience size A_{⋅} by a subtraction of the inverse of the deduplicated audience size of the first platform a minus the inverse of the estimated per-platform impression count r to generate a product (e.g., A_{⋅} *(1/a−1/r)) , and adding the product to the quotient of the deduplicated audience size of the first platform a divided by the estimated per-platform impression count r (e.g., (a/r)\hat{ }n), the quotient of the deduplicated audience size of the first platform a divided by the estimated per-platform impression count r is raised to the power of the number of platforms n.

The following is an example use of the above example Equations based on setting some variables to numerical values. For example, an example set of constants to estimate the deduplicated audience size of an individual platform a, are given as U=1000, A_{⋅}=500, R_{⋅}=600, n=4, and r=150. When these values are utilized with Equation 1 above, an estimate for the deduplicated audience size of an individual platform a is calculated as 159. This result is an impossibility because the estimate of 159 for the deduplicated audience size of an individual platform a is more than the number of estimated impressions per platform r (e.g., r=150, which is less than a=159). Utilizing the same values of constants (e.g., U=1000, A_{⋅}=500, R_{⋅}=600, n=4, and r=150) to estimate the deduplicated audience size of an individual platform a with the audience estimation equation represented in example Equation 10 above disclosed herein produces an estimate for the deduplicated audience size of an individual platform a=139. This result is logically valid because the estimate of 139 for the deduplicated audience size of an individual platform a is less than or equal to the number of estimated impressions per platform r (e.g., r=150, which is greater than a=139).

The audience estimation equation (e.g., Equation 10 above) disclosed herein produces valid estimates for the deduplicated audience size of an individual platform a even at the extreme case of independence such that A_{⋅}=R_{⋅} where each audience member contributed to only one impression in the pool (e.g., group, total partition) of impressions R_{⋅}.

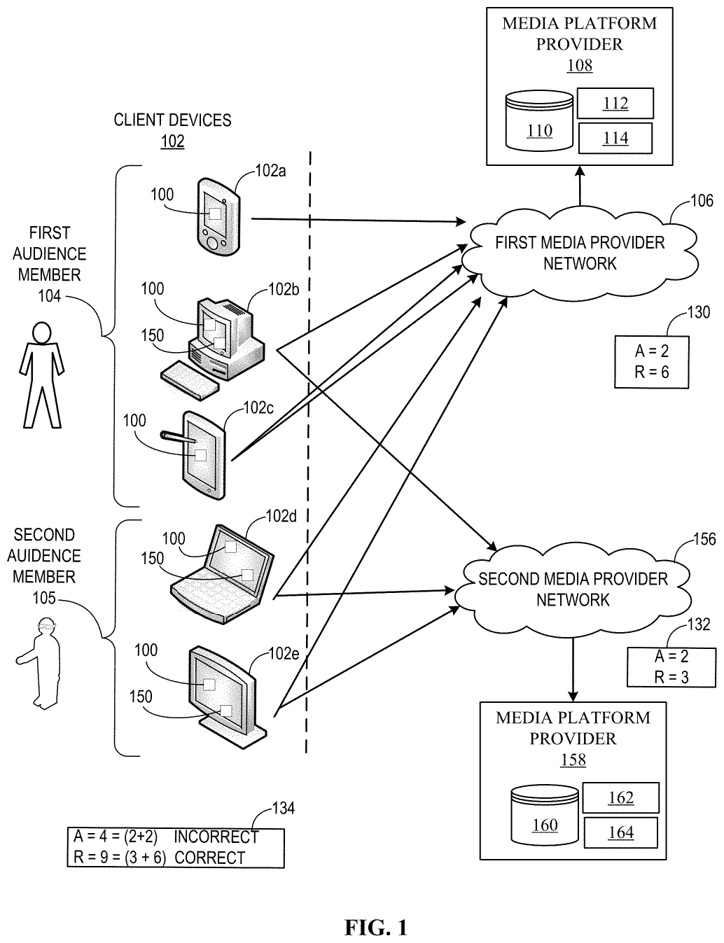

FIG. 1 illustrates example audience members with example client devices that report audience impression requests for Internet-based media to impression collection entities to facilitate estimating sizes of audiences exposed to different Internet-based media. Example network-based impression logging techniques are described below in connection with FIG. 1. Such example techniques may be used to collect audience size information for a first media platform provider 108 serving first media 100 and a second media platform provider 158 serving second media 150. FIG. 1 illustrates example client devices 102 that report impression requests for first Internet-based media 100 and second Internet-based media 150 to a first media platform provider 108 and a second media platform provider 158, respectively. The illustrated example of FIG. 1 includes the example client devices 102, an example first audience member 104, an example second audience member 105, an example first network 106, an example second network 156, an example first media platform provider 108, and an example second media platform provider 158. As used herein, a media platform provider (e.g., a platform) refers to any entity that serves media and/or collects impression data such as, for example, a website like a YouTube® website, a Hulu® website, a Spotify® website, a news website, a recipe website, digital television, digital radio, media apps, etc. In the illustrated example of FIG. 1, the first media platform provider 108 logs impressions in an example audience metrics datastore 110, and the second media platform provider 158 logs impressions in an example audience metrics datastore 160. In other examples, a single website such as a news website may include different sub-domain websites (e.g., sub-websites) such as a sports website, a finance website, and a weather website. In some such examples, the first media platform provider 108 logs impressions for the individual sub-domain websites as separate platforms serving media. In other such examples, the first media platform provider 108 logs impressions for the individual sub-domain websites collectively as the same platform. In the illustrated example, the audience members 104, 105 are subscribers of the database proprietor that operate the client devices 102 such that the database proprietor recognizes the client devices as operated by subscribers based on identifying information (e.g., first-party cookies) provided by the client devices 102 when reporting occurrences of impressions (e.g., occurrences of accesses to media) via impression requests sent by the client devices 102 to the media platform providers 108.

When the audience members 104 and 105 are subscribers of the media platform providers 108 and 158, the media platform providers 108 and 158 can deduplicate multiple impressions for the same media by the same audience member to generate unique audience sizes for that media because the media platform providers 108 and 158 can identify which subscribers correspond to which logged impressions. In examples disclosed herein, the media platform providers 108, 158 are database proprietors because they maintain a database of audience member demographic information (e.g. personally identifiable information (PII)) collected from their subscribers for use in collecting demographic impressions and generating audience metrics. In the illustrated example, the first media platform provider 108 includes an example media server 114 to serve the media 100 to the client devices 102, and the second media platform provider 158 includes an example media server 164 to serve the media 150 to the client devices 102. As used herein, “media” refers collectively and/or individually to content and/or advertisement(s). For example, the media servers 114, 164 may serve one or more of different types of media (e.g., movies, songs, advertisements, webpages, e-books, etc. in the form of any one or more of video, audio, images, text, etc.).

The example client devices 102 of the illustrated example may be any device capable of accessing media over a network (e.g., the example first network 106, or the example second network 156, etc.). For example, the client devices 102 may be an example mobile device 102a, an example computer 102b, 102d, an example tablet 102c, an example smart television 102e, and/or any other Internet-capable device or appliance. Examples disclosed herein may be used to collect impression information for any type of media including content and/or advertisements. Media may include advertising and/or content delivered via websites, streaming video, streaming audio, Internet protocol television (IPTV), movies, television, radio and/or any other vehicle for delivering media. In some examples, media includes user-generated media that is, for example, uploaded to media upload sites, such as a YouTube® website, and subsequently downloaded and/or streamed by one or more other client devices for playback. Media may also include advertisements. Advertisements are typically distributed with content (e.g., programming, on-demand video and/or audio). Traditionally, content is provided at little or no cost to the audience because it is subsidized by advertisers that pay to have their advertisements distributed with the content.

The example first network 106 is a communications network. The example first network 106 allows example impression requests from the example client devices 102 to the example first media platform provider 108. The example first network 106 may be a local area network, a wide area network, a cloud, or any other type of communications network. In some examples, the client devices 102 communicate with the first network 106 via the Internet.

The example second network 156 is a communications network. The example second network 156 allows example impression requests from the example client devices 102 to the example second media platform provider 158. The example second network 156 may be a local area network, a wide area network, a cloud, or any other type of communications network. In some examples, the client devices 102 communicate with the second network 156 via the Internet. In the illustrated example of FIG. 1, in response to accessing first media 100, the example client devices 102a, 102b, 102c, 102d, 102e report the occurrences of the impressions by sending impression requests through the example networks 106 to the example first media platform provider 108. For example, the client device 102c accesses the first media 100 twice and sends two impression requests (one impression request for each access) to the media platform provider 108. This results in the media platform provider 108 logging two impressions in the audience metrics datastore 110 for the example tablet 102c. The example client devices 102b, 102d, 102e access second media 150 and report the occurrences of the impressions by sending impression requests to the second media platform provider 158. In turn, the second media platform provider 158 logs impressions in the audience metrics datastore 160. Since the audience members 104, 105 are subscribers of the media platform providers 108, 158 in the illustrated example of FIG. 1, the media platform providers 108, 158 can identify logged impressions corresponding to the audience members 104, 105 and deduplicate duplicate impressions of the same media to generate unique audience sizes for the media 100, 150. For example, the example first media platform provider 108 records a unique audience size of two individuals and a total of 6 impressions for the example first media 100 as illustrated by example block 130, and the example second media platform provider 158 records a unique audience size of two individuals and a total of 3 impressions for the example second media 150 as illustrated by example block 132. As illustrated by example block 134, the total impressions (R) for the example media platform providers 108, 158 is additive such that 9 total impressions (R=9=3+6) are collected, while the deduplicated unique audience size (A) for the example media platform providers 108, 158 is not additive such that summing the two per-platform number of audience members observed by both media platform providers 108, 158 (A=4=2+2) is incorrect because the same two audience members 104, 105 were observed by both media platform providers 108, 158. In the example of FIG. 1, the deduplicated unique audience size for the example media platform providers 108, 158 is an audience size of two, while the additive estimate of the deduplicated unique audience size is four, which is incorrect.

In the illustrated example, the media platform providers 108, 158 are also impression collection entities. As impression collection entities, the example media platform providers 108, 158 log media impressions for the media 100, 150 based on impression requests received from the client devices 102 at audience metrics servers 112, 162 (e.g., accessible via an Internet protocol (IP) address or uniform resource locator (URL)) of the media platform providers 108, 158. In some examples, the media 100, 150 includes beacon instructions that, when executed by the client devices 102, cause the client devices 102 to send impression requests to the audience metrics servers 112, 162 of the media platform providers 108, 158 that provided the media 100, 150. In addition, the beacon instructions cause the client devices 102 to provide device and/or user identifiers and media identifiers in the impression requests. The device/user identifier may be any identifier used to associate demographic information with a user or users of the client devices 102. Example device/user identifiers include cookies, hardware identifiers (e.g., an international mobile equipment identity (IMEI), a mobile equipment identifier (MEID), a media access control (MAC) address, etc.), an app store identifier (e.g., a Google Android ID, an Apple ID, an Amazon ID, etc.), an open source unique device identifier (OpenUDID), an open device identification number (ODIN), a login identifier (e.g., a username), an email address, user agent data (e.g., application type, operating system, software vendor, software revision, etc.), an Ad ID (e.g., an advertising ID introduced by Apple, Inc. for uniquely identifying mobile devices for purposes of serving advertising to such mobile devices), third-party service identifiers (e.g., advertising service identifiers, device usage analytics service identifiers, demographics collection service identifiers), etc. In some examples, fewer or more device/user identifier(s) may be used. The media identifiers (e.g., embedded identifiers, embedded codes, embedded information, signatures, etc.) enable the first media platform provider 108 (e.g., impression collection entity 108) and/or the second media platform provider 158 (e.g., impression collection entity 158) to identify media items (e.g., the media 100 and/or the media 150) accessed via the client devices 102. The impression requests of the illustrated example cause the first media platform provider 108 and/or the second media platform provider 158 to log impressions for corresponding ones of the media 100 and/or the media 150 served or provided by the media platform providers 108, 158 to the client devices 102. In the illustrated example, an impression request sent to the first media platform provider 108 is a reporting to the first media platform provider 108 of an access to the media 100 via the client device 102. Similarly, an impression request sent to the second media platform provider 158 is a reporting to the second media platform provider 158 of an access to the media 150 via the client device 102. The impression requests may be implemented as a hypertext transfer protocol (HTTP) request. However, whereas a transmitted HTTP request identifies a webpage or other resource to be downloaded to a requesting client device from a server, the impression requests include audience measurement information (e.g., media identifiers and device/user identifier) as its payload. The example audience metrics server 112 of the first media platform provider 108 and/or the example audience metrics server 162 of the second media platform provider 158 to which impression requests are directed are programmed to log impressions using the audience measurement information (e.g., media identifiers, user and/or device identifiers, etc.) in the impression requests. In some examples, the audience metrics server 112 of the first media platform provider 108 and/or the audience metrics server 162 of the second media platform provider 158 may transmit a response based on receiving an impression request. However, a response to the impression request is not necessary. It is sufficient for the audience metrics server 112 of the first media platform provider 108 and/or the audience metrics server 162 of the second media platform provider 158 to receive an impression request to log an impression. As such, in some examples, the impressions request is a dummy HTTP request for the purpose of reporting an impression but to which a receiving server need not respond to the originating client device 102 of the impression request.

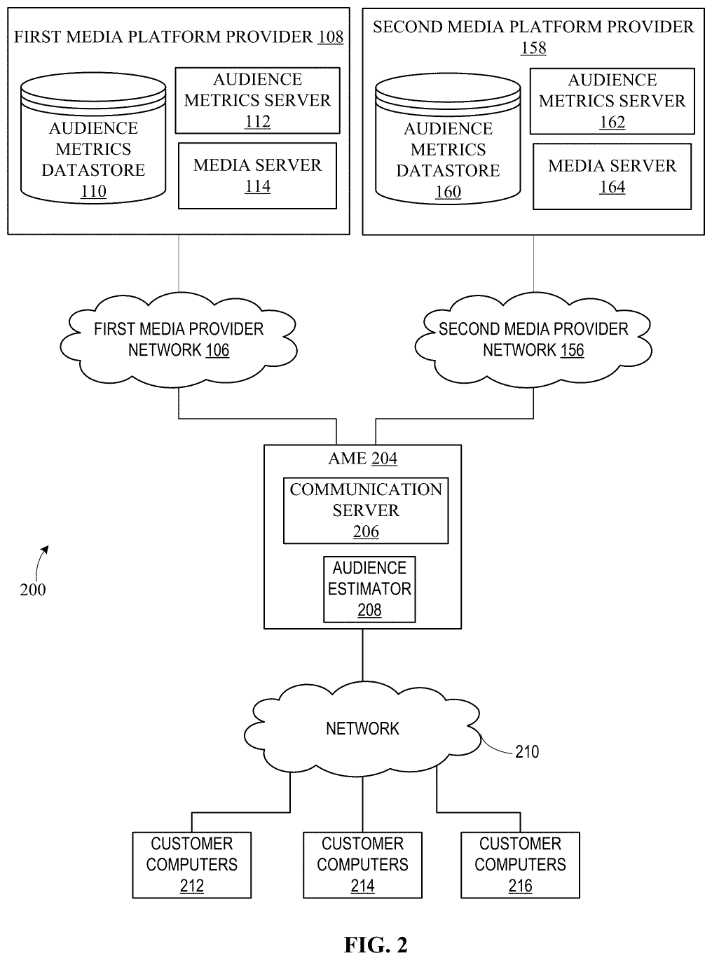

FIG. 2 illustrates an example environment 200 depicting an example audience measurement entity (AME) 204 in communication with the example media platform providers 108, 158 via corresponding ones of the media provider networks 106, 156, and in communication with customer computers 212, 214, 216 via an example network 210.

The example AME 204 is provided with an example communication server 206 to communicate with the media platform providers 108, 158 via the media provider networks 106, 156 and to communicate with the customer computers 212, 214, 216 via the example network 210. For example, the communication server 206 of the AME 204 communicates with the audience metrics servers 112, 162 of the media platform providers 108, 158 to request audience metrics data generated by the media platform providers 108, 158 in corresponding ones of the example audience metrics datastores 110, 160. The example networks 106, 156, 210 may be local area networks, wide area networks, cloud networks, or any other type of communications networks with which the AME communicates via the Internet.

The example customer computers 212, 214, 216 are computers of customers of the AME 204 that request audience metrics information regarding particular media of interest to the customers. For example, a customer of the AME 204 may be an advertiser (e.g., an advertising agency, a manufacturer/seller of goods and/or services, etc.) and/or media producer/publisher (e.g., a movie (or motion picture) production company, a media programming company, a record label, etc.) that is interested in understanding the audience reach of their media. By having audience reach, such customers can better understand the sizes of audiences and/or the demographic compositions of the audiences attained on different platforms (e.g., the first media platform provider 108 and/or the second media platform provider 158) for their media. In this manner, the customers of the AME 204 can make more informed decisions on where to spend advertising dollars and/or media publication dollars.

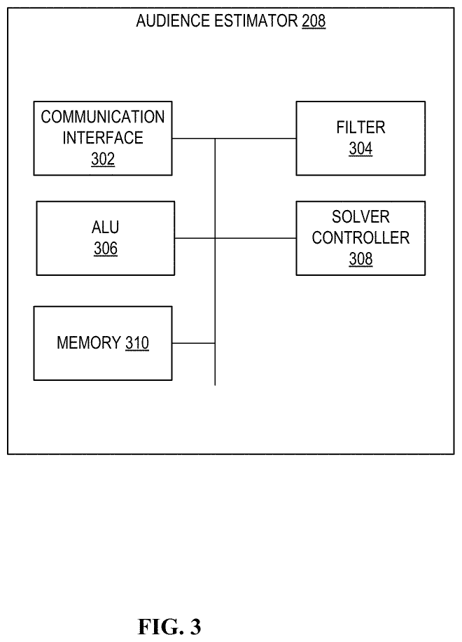

The example AME 204 also includes an example audience estimator 208. The example audience estimator 208 implements examples disclosed herein to estimate the deduplicated audience size of an individual platform a given the total impressions count R_{⋅}, the deduplicated total audience size A_{⋅}, and the number of platforms n. Example details of the audience estimator 208 are described below in connection with FIG. 3.

FIG. 3 is a block diagram of the example audience estimator 208 of FIG. 2. The example audience estimator 208 includes an example communication interface 302, an example filter 304, an example arithmetic logic unit (ALU) 306, an example solver controller 308, and example memory 310.

The example audience estimator 208 is provided with the example communication interface 302 to communicate with the example communication server 206 of FIG. 2. In this manner, the example audience estimator 208 can access audience metrics data obtained by the communication server 206 from the media platform providers 108, 158 (FIGS. 1 and/or 2). In addition, the example communication interface 302 enables the audience estimator 208 to communicate with the customer computers 212, 214, 216 via the network 210 of FIG. 2. In other examples, the communication interface 302 communicates directly with the first media platform provider 108, the example second media platform provider 158, and/or the customer computers 212, 214, 216.

The example filter 304 is configured to filter (e.g., exclude) impression count data from an example individual database proprietor (e.g., platform, impression collection entity, etc.) in response to the impression count data likely to skew the estimate of the deduplicated audience size of an individual platform a. In some examples, when the impression count per platform Rⱼ is known, the filter 304 may filter out outlier data from influencing the estimation of the deduplicated audience size of an individual platform a. For example, a first database proprietor may report 10 impression collections, while an example other four database proprietors may report 1000 impression collections. The example filter 304 may filter out the first database proprietor that reported only 10 impression collections.

The example ALU 306 is configured to perform mathematical calculations such as add, subtract, multiply, and/or divide. In some examples, the ALU 306 adds (e.g., accumulates, aggregates) the accessed impression counts (e.g., R_{1,} R_{2,} . . . Rₙ) from the individual database proprietors (e.g., platforms, impression collection entities, etc.) to generate a total number of impressions (e.g., total impressions count R_{⋅}). In these examples, the ALU 306 divides the total number of impressions by the number of database proprietors (e.g., platforms, impression collection entities, etc.) to generate estimated impression count data r.

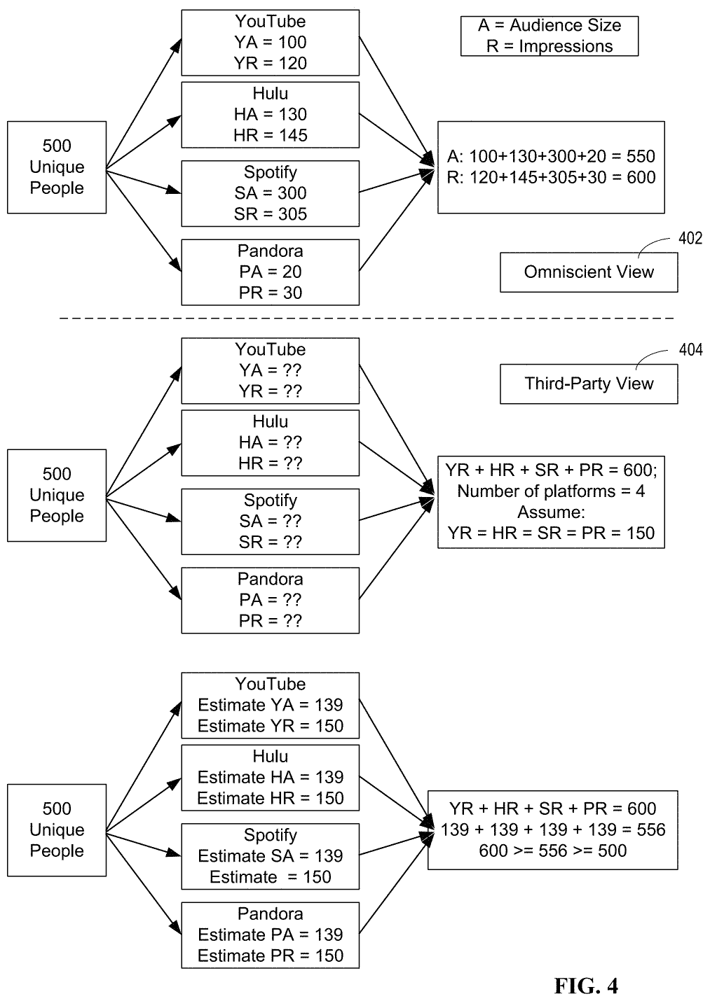

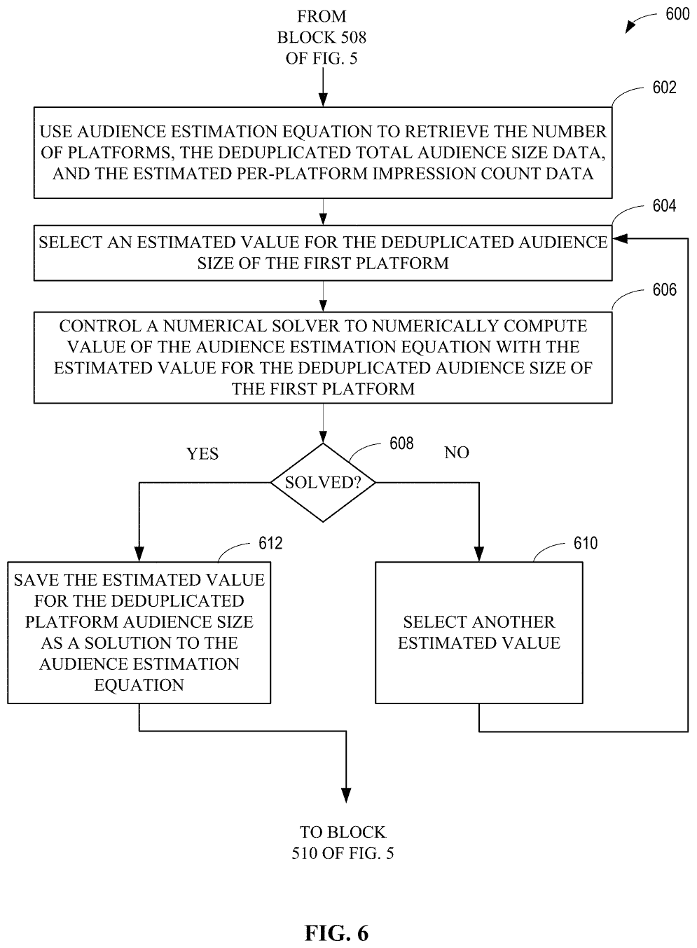

For example, if there are 100 media platform providers (e.g., database proprietors) with distinct impression counts (e.g., 12, 15, 17, 30, 2, etc.) for the same item of media served/provided by those media platform providers, the example ALU 306 may be used to add the impression counts together to generate a total impressions count R_{⋅} for that item of media across the 100 media platform providers. The example ALU 306 may then be used to divide the total number of impressions (e.g., 1,500) by the number of database proprietors (e.g., 100) resulting in the estimated impression count data r (e.g., 15). The example ALU 306 generates the estimated impression count data r which is used in the example audience metrics equation (e.g., Equation 10, above). The audience estimator 208 is provided with the example solver controller 308 to utilize numerical solvers (e.g., commercial solvers) to find solutions to equations representing audience sizes of individual media platform providers (e.g., the media platform providers 108, 158 of FIGS. 1 and/or 2). Computer-based implementations of example equations disclosed herein to estimate a deduplicated audience size of an individual platform a are described below in connection with FIG. 4. The example solver controller 308 is configured to utilize the number of media platform providers n, the deduplicated total audience size A_{⋅}, and the estimated impression count data r to estimate the deduplicated audience size of an individual platform a (e.g., a corresponding one of the media platform providers 108, 158). Example machine readable instructions to implement the solver controller 308 to solve equations is described below in connection with the flowchart of FIG. 6. The example solver controller 308 stores an answer (e.g., a result) generated by a numerical solver in the example memory 310. In examples disclosed herein, an answer of a numerical solver is an estimate of the deduplicated audience size of an individual platform a. In some examples, the example solver controller 308 may provide the answer (e.g., an estimated deduplicated audience size of an individual platform a) generated by the numerical solver to the example communication interface 302. The example communication interface 302 can then send the estimated deduplicated audience size of an individual platform a to a customer computer 212, 214, 216 (FIG. 2). In some examples, the example solver controller 308 may compare the total impressions count R_{⋅} to the deduplicated total audience size A_{⋅}, and verify a logical consistency of the deduplicated audience size A_{⋅} in response to the total impressions count R_{⋅} being equal to or greater than the deduplicated total audience size A_{⋅}. In other examples, the example solver controller 308 may compare the total impressions count R_{⋅} to the deduplicated total audience size A_{⋅}, and in response to the total impressions count R_{⋅} being equal to the deduplicated total audience size A_{⋅} declare the platforms are not interacting (e.g., audience members are mutually exclusive to a platform).

The audience estimator 208 is provided with the example memory 310 to store results and/or intermediate calculated values (e.g., from intermediate calculations) of the example ALU 306 and/or numerical solvers implemented by the solver controller 308.

FIG. 4 represents example computer-based operations to solve equations disclosed herein to estimate the deduplicated audience size of an individual platform a in accordance with teachings of this disclosure. In the example of FIG. 4, there is a unique audience size of 500 audience members. The audience members can access media (e.g., the media 100 of FIG. 1 and/or the media 150 of FIG. 1) from any media platform (e.g., the media platform provider 108, 158 of FIGS. 1 and/or 2). In the example of FIG. 4, there are four websites (e.g., a YouTube® website, a Hulu® website, a Spotify® website, and a Pandora® website), which serve as media platforms (e.g., the media platform providers 108, 158) to serve media and/or log impressions for user devices accessing the served media 100, 150. In the example of FIG. 4, the media of interest is a same item of media (e.g., an advertisement) served by all of the four websites. In the example, of FIG. 4, the audience members can access the media via any website, any number of times, but at least one access (e.g., impression) is necessary to be counted as a unique audience member for the individual website. For example, an audience member could access the media via the YouTube® website and the Hulu® website, but not access the media via the Spotify® website and the Pandora® website. The example audience member is counted as an audience member in audience metrics databases of the YouTube® website and the Hulu® website. This means that the YouTube® website platform and the Hulu® website platform are “interacting” in that the audience member is not in only one website and no others. When media platform providers are not “interacting” they are referred to as “mutually exclusive”. A “mutually exclusive” platform is one that counts an audience member that is not counted on another platform (e.g., the audience member did not visit other websites or other websites did not recognize the audience member as a subscriber or panelist and, thus, collected only a census impression without a unique audience count).

In the example of FIG. 4, an omniscient view 402 is shown. The omniscient view 402 (e.g., total, complete, perfect) depicts all the information regarding the audience sizes and the impression counts for the four websites. In the example omniscient view 402, the YouTube® website (e.g., the first media platform provider 108 of FIG. 1) logged 100 unique audience members (YA=100) (e.g., a deduplicated audience size of 100) with 120 impressions (YR=120). It is logically consistent that the number of impressions is greater than or equal to the audience size, because in order to be counted in the audience size there must be at least one impression. Also in the omniscient view 402, the Hulu® website has an audience size of 130 (HA=130), and an impression count of 145 (HR=145). Also in the omniscient view 402, the Spotify® website has an audience size of 300 (SA=300) and an impression count of 305 (SR=305). Also in the omniscient view 402, the Pandora® website has an audience size of 20 (PA=20) and an impression count of 30 (PR=30). Summing the deduplicated audience sizes (e.g., 100+130+300+20) results in an audience size of 550. This number is greater than the true audience size of 500 but is a valid answer because audience members can be a part of more than one website (e.g., mutual exclusion is not assumed). Summing the impressions (e.g., 120+145+305+30) results in a total impressions count R_{⋅} of 600. The example omniscient view 402 is useful for determining how example media (e.g., an advertisement, content, etc.) is accessed by different users on different platforms. However, the example data shown in the example omniscient view 402 is not available to the AME 204 (FIG. 2). The data available to the AME 204 (e.g., a third-party relative to the media platform providers 108, 158) is shown in the example third-party view 404.

In the example third-party view 404, the AME 204 has access to the audience size (e.g., 500), the number of platforms (e.g., 4), and the total number of impressions (e.g., 600) for the media item of interest served by the four platforms. The example AME 204 desires to estimate the deduplicated audience size of the individual platforms. Estimating the deduplicated audience size of the individual platforms is useful because clients for the example AME 204 may desire to know the best first-order estimate of audience sizes and impression counts per platform when there is no other information to distinguish the platforms. The example first-order estimates of audience sizes and impression counts per platform may be used to produce further estimates (e.g., estimate of unique audience size across a subset of the platforms). In other examples, the first-order estimates may be used as a starting point for modeling that requires a valid (e.g., logically consistent) starting point. With no distinguishing information relating to correlations of impression counts and/or audience sizes, the example third-party may divide the example total number of impressions R_{⋅} (e.g., 600) by the number of platforms n (e.g., 4) resulting in estimated impression count data r (e.g., 150). The example AME 204 may determine the deduplicated audience size of the first individual platform is the same deduplicated audience size of the second (and other subsequent) individual platforms as there is no distinguishing information between the media platform providers. The example AME 204 may use the audience estimation equation (e.g., Equation 10 above) to take the total number of impressions R_{⋅} (e.g., 600), the deduplicated total audience size A_{⋅} (e.g., 500), and the number of platforms n (e.g., 4) to generate the estimated deduplicated audience size of an individual platform a (e.g., 139). The answer is valid because adding 139 for each platform (e.g., 139+139+139+139) results in 556 which is in the range for an acceptable audience size in between the bounds of 500 unique people and the mutually exclusive answer of 600 (e.g., one audience member for one impression). If the answer was less than 500 or more than 600, it would not be a valid estimation for the deduplicated audience size.

Examples disclosed herein improve the accuracy of estimated unique (deduplicated) audience sizes because the results are logically consistent with total audience sizes unlike prior art solutions that generate logically inconsistent estimates. For example, in the example of FIG. 4, a prior solution would generate an audience size of 159 per platform which is logically inconsistent because adding 159 per platform results in 636 audience members, and 636 is greater than 600. This presents an impossibility because a per platform unique audience size (e.g., 636) cannot exceed a total unique audience size (e.g., 600) across all platforms. In other examples, if the impressions are 150 per platform, the audience size must be less than that number. However, the prior solution predicted higher than that number (159).

In some examples, the estimated deduplicated audience size a determined using examples disclosed herein may be used as an accurate reference for comparison against other audience size estimates determined by other entities (e.g., the media platform providers 108, 158 and/or other AMEs) even if those audience size estimates are derived using different techniques. In this manner, advertisers, media publishers, etc. can use the estimated deduplicated audience size a determined in accordance with teachings of this disclosure as an accurate reference metric by which to understand the number of people reached, even if that estimate is the same for multiple media platform providers.

While an example manner of implementing the audience estimator 208 of FIG. 2 is illustrated in FIG. 3, one or more of the elements, processes and/or devices illustrated in FIG. 3 may be combined, divided, rearranged, omitted, eliminated and/or implemented in any other way. Further, the example communication interface 302, the example filter 304, the example arithmetic logic unit 306, the example solver controller 308, the example memory 310 and/or, more generally, the example audience estimator of FIG. 2 may be implemented by hardware, software, firmware and/or any combination of hardware, software and/or firmware. Thus, for example, any of the example communication interface 302, the example filter 304, the example arithmetic logic unit 306, the example solver controller 308, the example memory 310 and/or, more generally, the example audience estimator 208 could be implemented by one or more analog or digital circuit(s), logic circuits, programmable processor(s), programmable controller(s), graphics processing unit(s) (GPU(s)), digital signal processor(s) (DSP(s)), application specific integrated circuit(s) (ASIC(s)), programmable logic device(s) (PLD(s)) and/or field programmable logic device(s) (FPLD(s)). When reading any of the apparatus or system claims of this patent to cover a purely software and/or firmware implementation, at least one of the example, communication interface 302, the example filter 304, the example arithmetic logic unit 306, the example solver controller 308, and/or the example memory 310 is/are hereby expressly defined to include a non-transitory computer readable storage device or storage disk such as a memory, a digital versatile disk (DVD), a compact disk (CD), a Blu-ray disk, etc. including the software and/or firmware. Further still, the example audience estimator 208 of FIG. 2 may include one or more elements, processes and/or devices in addition to, or instead of, those illustrated in FIG. 3, and/or may include more than one of any or all of the illustrated elements, processes and devices. As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

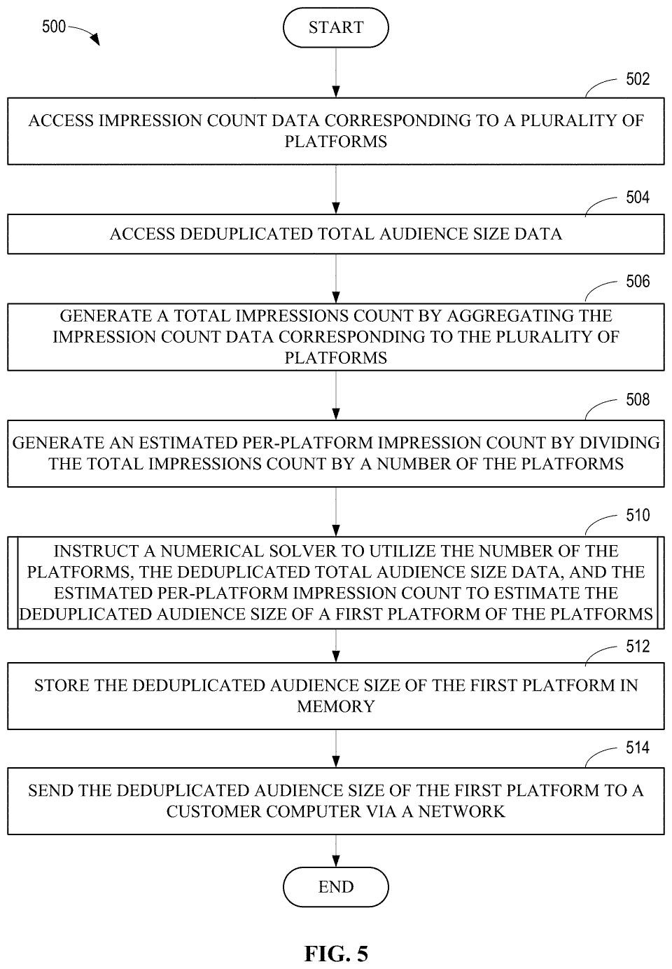

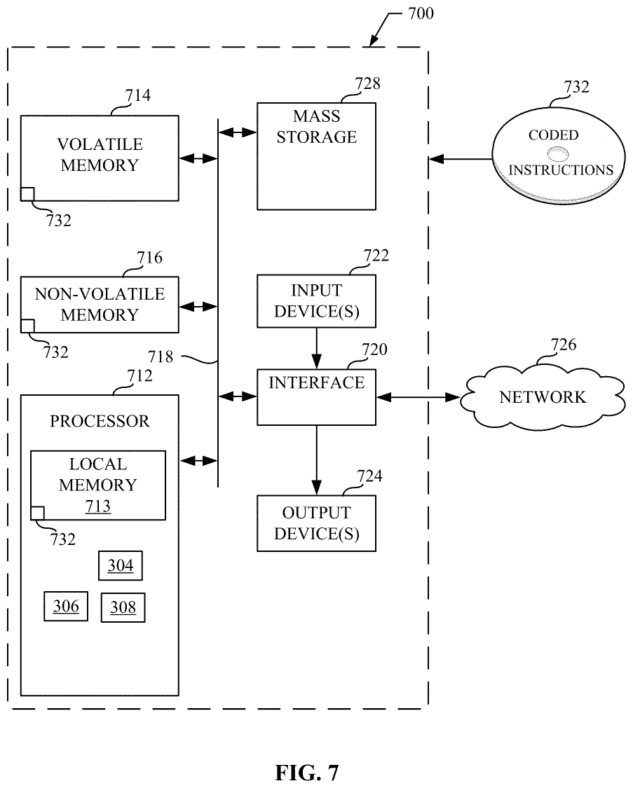

A flowchart representative of example hardware logic, machine readable instructions, hardware implemented state machines, and/or any combination thereof for implementing the audience estimator 208 of FIG. 2 is shown in FIGS. 5-6. The machine readable instructions may be one or more executable programs or portion(s) of an executable program for execution by a computer processor and/or processor circuitry, such as the processor 712 shown in the example processor platform 700 discussed below in connection with FIG. 7. The program may be embodied in software stored on a non-transitory computer readable storage medium such as a CD-ROM, a floppy disk, a hard drive, a DVD, a Blu-ray disk, or a memory associated with the processor 712, but the entire program and/or parts thereof could alternatively be executed by a device other than the processor 712 and/or embodied in firmware or dedicated hardware. Further, although the example program is described with reference to the flowchart illustrated in FIGS. 5-6, many other methods of implementing the example audience estimator 208 may alternatively be used. For example, the order of execution of the blocks may be changed, and/or some of the blocks described may be changed, eliminated, or combined. Additionally or alternatively, any or all of the blocks may be implemented by one or more hardware circuits (e.g., discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more devices (e.g., a multi-core processor in a single machine, multiple processors distributed across a server rack, etc).

The machine readable instructions described herein may be stored in one or more of a compressed format, an encrypted format, a fragmented format, a compiled format, an executable format, a packaged format, etc. Machine readable instructions as described herein may be stored as data or a data structure (e.g., portions of instructions, code, representations of code, etc.) that may be utilized to create, manufacture, and/or produce machine executable instructions. For example, the machine readable instructions may be fragmented and stored on one or more storage devices and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc. in order to make them directly readable, interpretable, and/or executable by a computing device and/or other machine. For example, the machine readable instructions may be stored in multiple parts, which are individually compressed, encrypted, and stored on separate computing devices, wherein the parts when decrypted, decompressed, and combined form a set of executable instructions that implement one or more functions that may together form a program such as that described herein.

In another example, the machine readable instructions may be stored in a state in which they may be read by processor circuitry, but require addition of a library (e.g., a dynamic link library (DLL)), a software development kit (SDK), an application programming interface (API), etc. in order to execute the instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable media, as used herein, may include machine readable instructions and/or program(s) regardless of the particular format or state of the machine readable instructions and/or program(s) when stored or otherwise at rest or in transit.

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example processes of FIGS. 5-6 may be implemented using executable instructions (e.g., computer and/or machine readable instructions) stored on a non-transitory computer and/or machine readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable storage device and/or storage disk and to exclude propagating signals and to exclude transmission media.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc. may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, and (7) A with B and with C. As used herein in the context of describing structures, components, items, objects and/or things, the phrase “at least one of A and B” is intended to refer to implementations including any of (1) at least one A, (2) at least one B, and (3) at least one A and at least one B. Similarly, as used herein in the context of describing structures, components, items, objects and/or things, the phrase “at least one of A or B” is intended to refer to implementations including any of (1) at least one A, (2) at least one B, and (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, and (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, and (3) at least one A and at least one B.

As used herein, singular references (e.g., “a”, “an”, “first”, “second”, etc.) do not exclude a plurality. The term “a” or “an” entity, as used herein, refers to one or more of that entity. The terms “a” (or “an”), “one or more”, and “at least one” can be used interchangeably herein. Furthermore, although individually listed, a plurality of means, elements or method actions may be implemented by, e.g., a single unit or processor. Additionally, although individual features may be included in different examples or claims, these may possibly be combined, and the inclusion in different examples or claims does not imply that a combination of features is not feasible and/or advantageous.

FIG. 5 is a flowchart representative of example machine readable instructions 500 that may be executed to implement the example audience estimator 208 of FIGS. 2 and/or 3 to estimate audience size per platform and impression count per platform based on deduplicated total audience size, a number of platforms, and a total impressions count from all the platforms.

At block 502, the example communication interface 302 (FIG. 3) accesses impression count data corresponding to a plurality of platforms (block 502). For example, the example communication interface 302 may receive impression count data from a plurality of platforms (e.g., the media platform providers 108, 158 of FIGS. 1 and/or 2) for media provided or served by those platforms. In other examples, the example communication interface 302 may directly collect impression count data from audience members accessing media via the platforms.

At block 504, the example communication interface 302 accesses deduplicated total audience size data (block 504). For example, the example communication interface 302 may access the deduplicated total audience size data from a database maintained or modelled by the example AME 204 (of FIG. 2). In some examples, the example AME 204 may generate the deduplicated total audience size data from accounts, email addresses, cookie IDs, device IDs, and/or any other identifier. In some examples, the example AME 204 may combine and/or derive the deduplicated total audience size data from merged data sketches (e.g., sketches or sketch data can be used to provide summary information about an underlying dataset without revealing PII data for individuals that may be included in the dataset). In some examples, the merged data sketches may be provided (e.g., generated, derived, etc.) by an example HyperLogLog method and/or an example Non-Uniform Bloom Filters method.

At block 506, the example arithmetic logic unit 306 (FIG. 3) generates a total impressions count by aggregating the impression count data corresponding to the plurality of platforms (block 506). For example, the arithmetic logic unit 306 may generate a total impressions count by aggregating the impression count data corresponding to the plurality of platforms by adding the total impression count R for a specific platform j (e.g., Rⱼ) for the plurality of platforms j. In other examples, the total impressions count R_{⋅} across the n platforms is given (e.g., a single media provider includes multiple sub-websites such as a news website with a sports webpage, a finance webpage, and weather webpage.)

At block 508, the example arithmetic logic unit 306 generates an estimated per-platform impression count by dividing the total impressions count by a number of the platforms (block 508). For example, the example arithmetic logic unit 306 may generate an estimated per-platform impression count by dividing the total impressions count by a number of the platforms (e.g., the media platform providers 108, 158 of FIGS. 1 and/or 2). In some examples, the estimated per-platform impression count r is the estimate of total impressions count R_{⋅} per number of platforms n.

At block 510, the example solver controller 308 (FIG. 3) instructs a numerical solver to utilize the number of the platforms, the deduplicated total audience size data, and the estimated per-platform impression count to estimate the deduplicated audience size of a first platform of the platforms. For example, the solver controller 308 may instruct a numerical solver to utilize the number of the platforms (e.g., the media platform providers 108, 158 of FIGS. 1 and/or 2), the deduplicated total audience size data, and the estimated per-platform impression count to estimate the deduplicated audience size of a first platform of the platforms. Block 510 may be implemented by controlling a numerical solver as described below in connection with FIG. 6.

At block 512, the example solver controller 308 stores the deduplicated audience size of the first platform in memory (block 512). For example, the example solver controller 308 may store the deduplicated audience size of the first media platform provider 108 in the memory 310 by storing the estimated audience size of the individual platform a with the estimated per-platform impression count r in the memory 310.

At block 514, the example communication interface 302 sends the deduplicated audience size of the first platform to a customer computer via a network (block 514). For example, the example communication interface 302 may send the deduplicated audience size a of the first media platform provider 108 to a customer computer 12, 214, 216 (FIG. 2) via the network 210 (FIG. 2). The example instructions 500 end.

FIG. 6 is a flowchart representative of example machine readable instructions 600 that may be executed to implement the example solver controller 308 (FIG. 3) of the example audience estimator 208 of FIGS. 2 and/or 3. The example machine readable instructions represented by FIG. 6 may be used to implement block 510 of FIG. 5. As described below, the example solver controller 308 utilizes the number of platforms, the deduplicated total audience size data, and the estimated per-platform impression count data to estimate the audience size of an individual platform (e.g., one of the media platform providers 108, 158 of FIGS. 1 and/or 2).

At block 602, the example solver controller 308 utilizes an audience estimation equation to retrieve the number of platforms, the deduplicated total audience size data, and the estimated per-platform impression count data (block 602). For example, the example solver controller 308 may utilize the audience estimation equation (e.g., Equation 10, above) to retrieve the number of platforms n, the deduplicated total audience size data A_{⋅}, and the estimated per-platform impression count r by loading the values from the memory 310 into registers and/or cache.

At block 604, the example solver controller 308 selects an estimated value for the deduplicated audience size of the first platform (block 604). For example, the example solver controller 308 may select a first estimated value (e.g., an initial estimate) for the deduplicated platform audience size data a in the audience estimation equation (e.g., Equation 10, above) by randomly selecting and/or generating a first value for the first media platform provider 108.

At block 606, the example solver controller 308 controls a numerical solver to numerically compute the result value of the audience estimation equation with the estimated value for the deduplicated platform audience size of the first platform (block 606). For example, the numerical solver may numerically compute the audience estimation equation (e.g., Equation 10, above) with the first estimated value for the deduplicated platform audience size of the first media platform provider 108 by calculating the left hand side of the audience estimation equation (e.g., Equation 10, above), and comparing the result of the left hand side with the right hand side of the audience estimation equation (e.g., Equation 10, above). For example, the right-hand side of the audience estimation equation (e.g., Equation 10, above) may be a constant (e.g., 1). For example, the left-hand side of the audience estimation equation (e.g., Equation 10, above) may be a multiplication of a total deduplicated audience size by a subtraction of the inverse of the deduplicated audience size of the first platform minus the inverse of the estimated per-platform impression count to generate a product, and adding the product to the quotient of the deduplicated audience size of the first platform divided by the estimated per-platform impression count, the quotient of the deduplicated audience size of the first platform divided by the estimated per-platform impression count raised to the power of the number of platforms.

At block 608, the example solver controller 308 determines if the estimated value (selected at block 604) for the deduplicated platform audience size computed by the numerical solver satisfies the audience estimation equation (block 608). For example, if the solver controller 308 determines the first estimated value for the deduplicated platform audience size computed by the numerical solver satisfies the audience estimation equation (e.g., Equation 10, above), control proceeds to block 612. Alternatively, if the example solver controller 308 determines that the first estimated value for the deduplicated platform audience size computed by the numerical solver does not satisfy the audience estimation equation (e.g., Equation 10, above), control proceeds to block 610.

At block 610, the example solver controller 308 selects another estimated value for the deduplicated audience size of the first platform (block 610). For example, the first estimated value for the deduplicated platform audience size may not result in solving the audience estimation equation (e.g., Equation 10, above) within a desired degree of precision (e.g., tolerance). In such instances, a more precise estimated value may be determined. For example, an initial estimated value of 1000 unique audience members may generate a result such as 1.36=1, while an initial estimated value of 1,524 unique audience members may generate a result such as 1.04=1, which may satisfy the audience estimation equation within a certain degree of precision. Control returns from block 610 to block 604.

At block 612, the example solver controller 308 saves the estimated value for the deduplicated platform audience size as a solution to the audience estimation equation (block 612). For example, the example solver controller 308 may save a first estimated value (or a subsequent estimated value if multiple iterations of blocks 604, 606, 608 are used to select and test multiple estimated values to find a suitable estimated value for the deduplicated platform audience size) for the deduplicated platform audience size in the example memory 310 as a solution to the audience estimation equation (e.g., Equation 10, above). Control proceeds to block 512 of FIG. 5. The example instructions 600 end.

FIG. 7 is a block diagram of an example processor platform 700 structured to execute the instructions of FIGS. 5-6 to implement the apparatus of FIGS. 2 and/or 3. The processor platform 700 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset or other wearable device, or any other type of computing device.

The processor platform 700 of the illustrated example includes a processor 712. The processor 712 of the illustrated example is hardware. For example, the processor 712 can be implemented by one or more integrated circuits, logic circuits, microprocessors, GPUs, DSPs, or controllers from any desired family or manufacturer. The hardware processor may be a semiconductor based (e.g., silicon based) device. In this example, the processor 712 implements the example filter 304, the example arithmetic logic unit 306, and the example solver controller 308 of FIG. 3.

The processor 712 of the illustrated example includes a local memory 713 (e.g., a cache). The processor 712 of the illustrated example is in communication with a main memory including a volatile memory 714 and a non-volatile memory 716 via a bus 718. The volatile memory 714 may be implemented by Synchronous Dynamic Random Access Memory (SDRAM), Dynamic Random Access Memory (DRAM), RAMBUS® Dynamic Random Access Memory (RDRAM®) and/or any other type of random access memory device. The non-volatile memory 716 may be implemented by flash memory and/or any other desired type of memory device. Access to the main memory 714, 716 is controlled by a memory controller. In some examples, the volatile memory 714 and/or the non-volatile memory 716 implement the memory 310 of FIG. 3.

The processor platform 700 of the illustrated example also includes an interface circuit 720. The interface circuit 720 may be implemented by any type of interface standard, such as an Ethernet interface, a universal serial bus (USB), a Bluetooth® interface, a near field communication (NFC) interface, and/or a PCI express interface.

In the illustrated example, one or more input devices 722 are connected to the interface circuit 720. The input device(s) 722 permit(s) a user to enter data and/or commands into the processor 712. The input device(s) can be implemented by, for example, an audio sensor, a microphone, a camera (still or video), a keyboard, a button, a mouse, a touchscreen, a track-pad, a trackball, isopoint and/or a voice recognition system.

One or more output devices 724 are also connected to the interface circuit 720 of the illustrated example. The output devices 724 can be implemented, for example, by display devices (e.g., a light emitting diode (LED), an organic light emitting diode (OLED), a liquid crystal display (LCD), a cathode ray tube display (CRT), an in-place switching (IPS) display, a touchscreen, etc.), a tactile output device, a printer and/or speaker. The interface circuit 720 of the illustrated example, thus, typically includes a graphics driver card, a graphics driver chip and/or a graphics driver processor.

The interface circuit 720 of the illustrated example also includes a communication device such as a transmitter, a receiver, a transceiver, a modem, a residential gateway, a wireless access point, and/or a network interface to facilitate exchange of data with external machines (e.g., computing devices of any kind) via a network 726. The communication can be via, for example, an Ethernet connection, a digital subscriber line (DSL) connection, a telephone line connection, a coaxial cable system, a satellite system, a line-of-site wireless system, a cellular telephone system, etc. In the illustrated example, the example interface circuit 720 implements the communication interface 302 of FIG. 3.

The processor platform 700 of the illustrated example also includes one or more mass storage devices 728 for storing software and/or data. Examples of such mass storage devices 728 include floppy disk drives, hard drive disks, compact disk drives, Blu-ray disk drives, redundant array of independent disks (RAID) systems, and digital versatile disk (DVD) drives. In some examples, the one or more mass storage devices 728 implement the memory 310 of FIG. 3.

Machine executable instructions 732 represented in FIGS. 5-6 may be stored in the mass storage device 728, in the volatile memory 714, in the non-volatile memory 716, and/or on a removable non-transitory computer readable storage medium such as a CD or DVD.

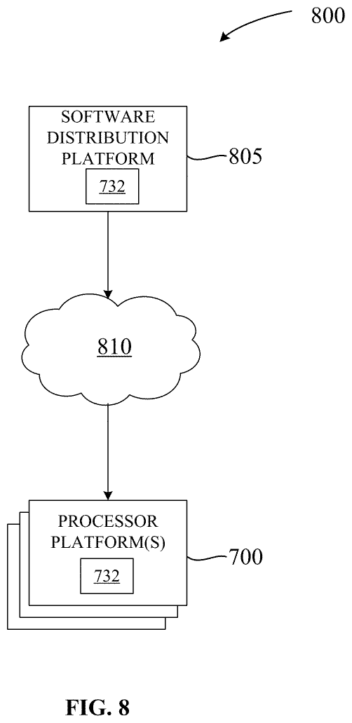

A block diagram illustrating an example software distribution platform 805 to distribute software such as the example computer readable instructions 732 of FIG. 7 to third parties is illustrated in FIG. 8. The example software distribution platform 805 may be implemented by any computer server, data facility, cloud service, etc., capable of storing and transmitting software to other computing devices. The third parties may be customers of the entity owning and/or operating the software distribution platform. For example, the entity that owns and/or operates the software distribution platform may be a developer, a seller, and/or a licensor of software such as the example computer readable instructions 732 of FIG. 8. The third parties may be consumers, users, retailers, OEMs, etc., who purchase and/or license the software for use and/or re-sale and/or sub-licensing. In the illustrated example, the software distribution platform 805 includes one or more servers and one or more storage devices. The storage devices store the computer readable instructions 732, which may correspond to the example computer readable instructions 732 of FIGS. 5-6, as described above. The one or more servers of the example software distribution platform 805 are in communication with a network 810, which may correspond to any one or more of the Internet and/or any of the example networks 726 described above. In some examples, the one or more servers are responsive to requests to transmit the software to a requesting party as part of a commercial transaction. Payment for the delivery, sale and/or license of the software may be handled by the one or more servers of the software distribution platform and/or via a third party payment entity. The servers enable purchasers and/or licensors to download the computer readable instructions 732 from the software distribution platform 805. For example, the software, which may correspond to the example computer readable instructions 732 of FIG. 7, may be downloaded to the example processor platform 700, which is to execute the computer readable instructions 732 to implement the audience estimator. In some example, one or more servers of the software distribution platform 805 periodically offer, transmit, and/or force updates to the software (e.g., the example computer readable instructions 732 of FIG. 7) to ensure improvements, patches, updates, etc. are distributed and applied to the software at the end user devices.

From the foregoing, it will be appreciated that example methods, apparatus and articles of manufacture have been disclosed that estimate a deduplicated audience size of an individual platform given deduplicated total audience size data. The disclosed methods, apparatus and articles of manufacture improve the efficiency of using a computing device by improving the result generated by the computing device for estimating the deduplicated audience size of an individual media platform provider. The disclosed methods, apparatus and articles of manufacture are accordingly directed to one or more improvement(s) in the functioning of a computer.

Disclosed herein are example systems, apparatus and methods for estimating a deduplicated audience size of an individual platform given deduplicated total audience size data. Further examples and combinations thereof include the following:

Example 1 includes an apparatus for estimating a deduplicated audience size, the apparatus comprising a communication interface to access impression count data corresponding to a plurality of platforms, and access deduplicated total audience size data, an arithmetic logic unit to generate a total impressions count by aggregating the impression count data corresponding to the plurality of platforms, generate an estimated per-platform impression count by dividing the total impressions count by a number of the platforms, a solver controller to instruct a numerical solver to utilize the number of the platforms, the deduplicated total audience size data, and the estimated per-platform impression count to estimate the deduplicated audience size of a first platform of the platforms, and memory to store the deduplicated audience size of the first platform.

Example 2 includes the apparatus of example 1, wherein the communication interface is to send the deduplicated audience size of the first platform to a customer computer via a network.

Example 3 includes the apparatus of example 1, wherein the solver controller is to cause the numerical solver to solve an audience estimation equation to estimate the deduplicated audience size of the first platform.

Example 4 includes the apparatus of example 1, wherein the solver controller is to cause the numerical solver to solve an audience estimation equation to estimate the deduplicated audience size of the first platform by multiplying a total deduplicated audience size by a subtraction of an inverse of the deduplicated audience size of the first platform minus the inverse of the estimated per-platform impression count to generate a product, and adding the product to a quotient of the deduplicated audience size of the first platform divided by the estimated per-platform impression count, the quotient being raised to a power of a number of platforms.

Example 5 includes the apparatus of example 1, wherein the solver controller is to cause the numerical solver to solve an audience estimation equation to estimate the deduplicated audience size of the first platform based on Shannon entropy and LaGrange multipliers.

Example 6 includes the apparatus of example 1, wherein the solver controller is to cause the numerical solver to select a first estimated value for the deduplicated audience size of the first platform, and in response to the first estimated value for the deduplicated audience size of the first platform not satisfying an audience estimation equation, select a second estimated value for the deduplicated audience size.

Example 7 includes the apparatus of example 1, wherein the solver controller is to compare the total impressions count to the deduplicated total audience size, and verify a logical consistency of the deduplicated audience size in response to the total impressions count being equal to or greater than the deduplicated total audience size.

Example 8 includes a method for estimating a deduplicated audience size, the method comprising generating, by executing an instruction with a processor, a total impressions count by aggregating impression count data corresponding to a plurality of platforms, generating, by executing an instruction with the processor, an estimated per-platform impression count by dividing the total impressions count by a number of the platforms, instructing, by executing an instruction with the processor, a numerical solver to utilize a number of platforms, deduplicated total audience size data, and the estimated per-platform impression count to estimate the deduplicated audience size of a first platform of the platforms, and storing, by executing an instruction with the processor, the deduplicated audience size of the first platform in memory.

Example 9 includes the method of example 8, further including sending the deduplicated audience size of the first platform to a customer computer via a network.

Example 10 includes the method of example 8, wherein the instructing of the numerical solver includes causing the numerical solver to solve an audience estimation equation to estimate the deduplicated audience size of the first platform.

Example 11 includes the method of example 8, wherein the instructing of the numerical solver includes causing the numerical solver to solve an audience estimation equation to estimate the deduplicated audience size of the first platform by multiplying a total deduplicated audience size by a subtraction of an inverse of the deduplicated audience size of the first platform minus an inverse of the estimated per-platform impression count to generate a product, and adding the product to a quotient of the deduplicated audience size of the first platform divided by the estimated per-platform impression count, the quotient being raised to a power of a number of platforms.

Example 12 includes the method of example 8, wherein the instructing of the numerical solver includes causing the numerical solver to solve an audience estimation equation to estimate the deduplicated audience size of the first platform based on Shannon entropy and LaGrange multipliers.

Example 13 includes the method of example 8, wherein the instructing of the numerical solver includes causing the numerical solver to select a first estimated value for the deduplicated audience size of the first platform, and in response to the first estimated value for the deduplicated audience size of the first platform not satisfying an audience estimation equation, selecting a second estimated value for the deduplicated audience size.

Example 14 includes the method of example 8, further including comparing the total impressions count to the deduplicated total audience size, and verifying a logical consistency of the deduplicated audience size in response to the total impressions count being equal to or greater than the deduplicated total audience size.

Example 15 includes a non-transitory computer readable storage medium comprising computer readable instructions that, when executed, cause one or more processors to, at least generate a total impressions count by aggregating impression count data corresponding to a plurality of platforms, generate an estimated per-platform impression count by dividing the total impressions count by a number of the platforms, instruct a numerical solver to utilize a number of the platforms, deduplicated total audience size data, and the estimated per-platform impression count to estimate the deduplicated audience size of a first platform of the platforms, and store the deduplicated audience size of the first platform in memory.

Example 16 includes the non-transitory computer readable storage medium of example 15, wherein the computer readable instructions, when executed, cause the one or more processors to send the deduplicated audience size of the first platform to a customer computer via a network.

Example 17 includes the non-transitory computer readable storage medium of example 15, wherein the computer readable instructions, when executed, cause the one or more processors to cause the numerical solver to solve an audience estimation equation to estimate the deduplicated audience size of the first platform.

Example 18 includes the non-transitory computer readable storage medium of example 15, wherein the computer readable instructions, when executed, cause the one or more processors to cause the numerical solver to solve an audience estimation equation to estimate the deduplicated audience size of the first platform by multiplying a total deduplicated audience size by a subtraction of an inverse of the deduplicated audience size of the first platform minus an inverse of the estimated per-platform impression count to generate a product, and adding the product to a quotient of the deduplicated audience size of the first platform divided by the estimated per-platform impression count, the quotient being raised to a power of a number of platforms.

Example 19 includes the non-transitory computer readable storage medium of example 15, wherein the computer readable instructions, when executed, cause the one or more processors to cause the numerical solver to solve an audience estimation equation to estimate the deduplicated audience size of the first platform based on Shannon entropy and LaGrange multipliers.

Example 20 includes the non-transitory computer readable storage medium of example 15, wherein the computer readable instructions, when executed, cause the one or more processors to cause the numerical solver to select a first estimated value for the deduplicated audience size of the first platform, and in response to the first estimated value for the deduplicated audience size of the first platform not satisfying an audience estimation equation, select a second estimated value for the deduplicated audience size.

Example 21 includes the non-transitory computer readable storage medium of example 15, wherein the computer readable instructions, when executed, cause the one or more processors to compare the total impressions count to the deduplicated total audience size, and verify a logical consistency of the deduplicated audience size in response to the total impressions count being equal to or greater than the deduplicated total audience size.

Example 22 includes a server to distribute first instructions on a network, the server comprising at least one storage device including second instructions, and at least one processor to execute the second instructions to transmit the first instructions over the network, the first instructions, when executed, to cause at least one device to access impression count data corresponding to a plurality of platforms, access deduplicated total audience size data, generate a total impressions count by aggregating the impression count data corresponding to the plurality of platforms, generate an estimated per-platform impression count by dividing the total impressions count by a number of the platforms, instruct a numerical solver to utilize the number of the platforms, the deduplicated total audience size data, and the estimated per-platform impression count to estimate the deduplicated audience size of a first platform of the platforms, and store the deduplicated audience size of the first platform in memory.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

What is claimed is:

1. An apparatus for estimating a deduplicated audience size, the apparatus comprising:
a communication interface to:
access impression count data corresponding to a plurality of platforms; and
access deduplicated total audience size data;
an arithmetic logic unit to:
generate a total impressions count by aggregating the impression count data corresponding to the plurality of platforms;
generate an estimated per-platform impression count by dividing the total impressions count by a number of the platforms;
a solver controller to:
instruct a numerical solver to utilize the number of the platforms, the deduplicated total audience size data, and the estimated per-platform impression count to estimate the deduplicated audience size of a first platform of the platforms; and
memory to store the deduplicated audience size of the first platform.

2. The apparatus of claim 1, wherein the communication interface is to send the deduplicated audience size of the first platform to a customer computer via a network.

3. The apparatus of claim 1, wherein the solver controller is to cause the numerical solver to solve an audience estimation equation to estimate the deduplicated audience size of the first platform.

4. The apparatus of claim 1, wherein the solver controller is to cause the numerical solver to solve an audience estimation equation to estimate the deduplicated audience size of the first platform by multiplying a total deduplicated audience size by a subtraction of an inverse of the deduplicated audience size of the first platform minus the inverse of the estimated per-platform impression count to generate a product, and adding the product to a quotient of the deduplicated audience size of the first platform divided by the estimated per-platform impression count, the quotient being raised to a power of a number of platforms.

5. The apparatus of claim 1, wherein the solver controller is to cause the numerical solver to solve an audience estimation equation to estimate the deduplicated audience size of the first platform based on Shannon entropy and LaGrange multipliers.

6. The apparatus of claim 1, wherein the solver controller is to cause the numerical solver to select a first estimated value for the deduplicated audience size of the first platform, and in response to the first estimated value for the deduplicated audience size of the first platform not satisfying an audience estimation equation, select a second estimated value for the deduplicated audience size.

7. The apparatus of claim 1, wherein the solver controller is to compare the total impressions count to the deduplicated total audience size, and verify a logical consistency of the deduplicated audience size in response to the total impressions count being equal to or greater than the deduplicated total audience size.

8. A method for estimating a deduplicated audience size, the method comprising:
generating, by executing an instruction with a processor, a total impressions count by aggregating impression count data corresponding to a plurality of platforms;
generating, by executing an instruction with the processor, an estimated per-platform impression count by dividing the total impressions count by a number of the platforms;
instructing, by executing an instruction with the processor, a numerical solver to utilize a number of platforms, deduplicated total audience size data, and the estimated per-platform impression count to estimate the deduplicated audience size of a first platform of the platforms; and
storing, by executing an instruction with the processor, the deduplicated audience size of the first platform in memory.

9. The method of claim 8, further including sending the deduplicated audience size of the first platform to a customer computer via a network.

10. The method of claim 8, wherein the instructing of the numerical solver includes causing the numerical solver to solve an audience estimation equation to estimate the deduplicated audience size of the first platform.

11. The method of claim 8, wherein the instructing of the numerical solver includes causing the numerical solver to solve an audience estimation equation to estimate the deduplicated audience size of the first platform by multiplying a total deduplicated audience size by a subtraction of an inverse of the deduplicated audience size of the first platform minus an inverse of the estimated per-platform impression count to generate a product, and adding the product to a quotient of the deduplicated audience size of the first platform divided by the estimated per-platform impression count, the quotient being raised to a power of a number of platforms.

12. The method of claim 8, wherein the instructing of the numerical solver includes causing the numerical solver to solve an audience estimation equation to estimate the deduplicated audience size of the first platform based on Shannon entropy and LaGrange multipliers.

13. The method of claim 8, wherein the instructing of the numerical solver includes causing the numerical solver to select a first estimated value for the deduplicated audience size of the first platform, and in response to the first estimated value for the deduplicated audience size of the first platform not satisfying an audience estimation equation, selecting a second estimated value for the deduplicated audience size.

14. The method of claim 8, further including comparing the total impressions count to the deduplicated total audience size, and verifying a logical consistency of the deduplicated audience size in response to the total impressions count being equal to or greater than the deduplicated total audience size.

15. A non-transitory computer readable storage medium comprising computer readable instructions that, when executed, cause one or more processors to, at least:
generate a total impressions count by aggregating impression count data corresponding to a plurality of platforms;
generate an estimated per-platform impression count by dividing the total impressions count by a number of the platforms;
instruct a numerical solver to utilize a number of the platforms, deduplicated total audience size data, and the estimated per-platform impression count to estimate the deduplicated audience size of a first platform of the platforms; and
store the deduplicated audience size of the first platform in memory.

16. The non-transitory computer readable storage medium of claim 15, wherein the computer readable instructions, when executed, cause the one or more processors to send the deduplicated audience size of the first platform to a customer computer via a network.

17. The non-transitory computer readable storage medium of claim 15, wherein the computer readable instructions, when executed, cause the one or more processors to cause the numerical solver to solve an audience estimation equation to estimate the deduplicated audience size of the first platform.

18. The non-transitory computer readable storage medium of claim 15, wherein the computer readable instructions, when executed, cause the one or more processors to cause the numerical solver to solve an audience estimation equation to estimate the deduplicated audience size of the first platform by multiplying a total deduplicated audience size by a subtraction of an inverse of the deduplicated audience size of the first platform minus an inverse of the estimated per-platform impression count to generate a product, and adding the product to a quotient of the deduplicated audience size of the first platform divided by the estimated per-platform impression count, the quotient being raised to a power of a number of platforms.

19. The non-transitory computer readable storage medium of claim 15, wherein the computer readable instructions, when executed, cause the one or more processors to cause the numerical solver to solve an audience estimation equation to estimate the deduplicated audience size of the first platform based on Shannon entropy and LaGrange multipliers.

20. The non-transitory computer readable storage medium of claim 15, wherein the computer readable instructions, when executed, cause the one or more processors to cause the numerical solver to select a first estimated value for the deduplicated audience size of the first platform, and in response to the first estimated value for the deduplicated audience size of the first platform not satisfying an audience estimation equation, select a second estimated value for the deduplicated audience size.

21. The non-transitory computer readable storage medium of claim 15, wherein the computer readable instructions, when executed, cause the one or more processors to compare the total impressions count to the deduplicated total audience size, and verify a logical consistency of the deduplicated audience size in response to the total impressions count being equal to or greater than the deduplicated total audience size.

22. A server to distribute first instructions on a network, the server comprising:
at least one storage device including second instructions; and
at least one processor to execute the second instructions to transmit the first instructions over the network, the first instructions, when executed, to cause at least one device to:
access impression count data corresponding to a plurality of platforms;
access deduplicated total audience size data;
generate a total impressions count by aggregating the impression count data corresponding to the plurality of platforms;
generate an estimated per-platform impression count by dividing the total impressions count by a number of the platforms;
instruct a numerical solver to utilize the number of the platforms, the deduplicated total audience size data, and the estimated per-platform impression count to estimate the deduplicated audience size of a first platform of the platforms; and
store the deduplicated audience size of the first platform in memory.
